(19) United States
(12) Patent Application Publication
(10) Pub. No.: US 2007/0239964 A1
(43) Pub. Date: Oct. 11, 2007

(54) System and method for dynamically reconfigurable computer architecture based on network connected components

(76) Inventor: Gregory J. Denault, (US)

Correspondence Address: NIXON PEABODY, LLP, 401 9TH STREET, NW, SUITE 900, WASHINGTON, DC, 20004-2128, US

(21) Appl. No.: 11/717,775

(22) Filed: Mar. 14, 2007

Related U.S. Application Data
(60) Provisional application No. 60/782,538, filed on Mar. 16, 2006.

(51) Int. Cl. G06F 15/177; G06F 15/00

(52) U.S. Cl. 712/11

(57) ABSTRACT

A method, system, computer program product, and devices corresponding to a computer architecture, a computer management system, a programming model, and a programming language product for high performance computing, according to the exemplary embodiments.

### CROSS REFERENCE TO RELATED DOCUMENTS

The present invention claims benefit of priority to U.S. Provisional Patent Application Ser. No. 60/782,538 to Gregory DENAULT, entitled “SYSTEM AND METHOD FOR DYNAMICALLY RECONFIGURABLE COMPUTER ARCHITECTURE BASED ON NETWORK CONNECTED COMPONENTS,” filed Mar. 16, 2006, the entire disclosure of which is hereby incorporated by reference herein.

### BACKGROUND OF THE INVENTION

1. Field of the Invention

The present invention generally relates to the field of High Performance Computer Architecture, and more particularly to a method and system for arranging computer elements as a set of network connected components, to a network design, to a method and system for allocating and configuring a subset of these components at runtime to perform specified computation, and to a method and system for selecting and programming components from computer elements to perform specified computation.

2. Discussion of the Background

The biggest problem facing computer architects is that computer designs become fixed at the time of manufacture. Consequently, each computer design embodies a set of assumptions and design compromises thought to provide the best average performance for a range of applications.

Current High Performance Computers are designed according to the same fundamental design principle: a central processor is connected to external devices—memory, disk drives, I/O devices, etc.—by means of a system bus of uniform design with a direct interface to the central processor's address/data bus. The ensemble, including a central processor and associated devices, collectively form a processing system that is largely fixed at the time of manufacture with allowances made for subsequent addition, replacement, or removal of system bus compatible devices. The central processor designs range from the modern microprocessor to highly specialized custom processors targeted to efficiently perform certain types of computations. The Intel Pentium and IBM Power PC, examples of modern microprocessors, have found their greatest utility in today's personal computer (PC), while the specialized custom processors, such as those designed and manufactured by Cray and Fujitsu, are specialized computational platforms.

It is commonly held that High Performance Computation is achieved by performing multiple operations simultaneously. This is accomplished either by interconnecting a plethora of microprocessors, by custom processor designs employing numerous execution units, or by hybrid systems that combine microprocessors with custom computational accelerators.

Computational accelerators are designed to augment the performance of the microprocessor by offloading compute intensive sections of application codes. Such offloading occurs under the direct management of the microprocessor. Computational accelerators maintain a close coupled relationship to the microprocessor host over its system bus. Typically, a microprocessor host is employed for each computational accelerator. Increasing the number of computational accelerators results in a corresponding increase in the number of host microprocessors.

Computational accelerators are often built with Field Programmable Gate Array (FPGA) type components. The FPGA internal logic can be altered to suite computational objectives. Such accelerators use significant chip resources to communicate with the microprocessor host. Also, such accelerators are invariably configured to directly operate on the standard data formats, including floating point and double precision floating point, commonly used by microprocessor hosts.

The combination of low-priced PCs, low cost packet switched networks and a freely available operating system (Linux) has lead to the development of today's most popular High Performance Computer, the Cluster. A Cluster includes multiple PCs packaged in a space efficient manner and sharing a packet switched local area network (LAN).

Programming Clusters is accomplished with popular languages like C and C++ that employ library extensions in order to accomplish data sharing amongst the PCs in the cluster. Each cluster PC runs a version of the Linux operating system which includes optional software components to manage the communication of data amongst the PCs.

High Performance Computing is achieved on a cluster when a large number of PCs are programmed in such a way that each of them is assigned a subset of the computational task and each PC employs library components as needed to accomplish the desired inter-PC communication pattern.

Specialized High Performance Computing systems are conceived and built solely for the purpose of computation and are highly specialized. Often they are suitable for a limited set of application domains (e.g., computational fluid dynamics, or molecular modeling). Because of their unique architecture these systems operate under custom control programs and job submission managers.

Programming specialized High Performance Computing systems is generally accomplished with more specialized and adapted languages (e.g., High Performance Fortran) that have platform specific backend code generators suitable to the target machine.

Current efforts to improve computational performance are slowed by the difficult research effort to reduce integrated circuit device feature size in order to increase both the number and clock rate of computational circuits per chip.

In general, the computational effectiveness of today's High Performance Computational systems depends on the effectiveness of the computational algorithm design and implementation. Consequently, architectural improvements that alter the relationship between execution speed and data communication speed employ frequent modification and tuning of algorithms to derive improved performance.

Cost effective use of High Performance Computing systems is achieved when codes are used in a high volume production computing fashion.

The PC based cluster represents a “one size fits all” approach where the number of PCs in the cluster is scalable to meet the customers overall throughput requirement, while custom designed machines are more optimized for specific application domains. In practice, clusters perform at approximately 10% of their rated speed.

### SUMMARY OF THE INVENTION

Therefore, a new high performance computer architecture, a new protocol for computer networks, a new programming model, and new utilization model are needed. This new architecture should overcome the fixed nature of the architecture of both the general purpose microprocessor and the specialized custom processor. This new high performance architecture should scale in size to thousands of components without the need for host computer management. This new high performance architecture should exploit an ultra high density network architecture as an active element in the computational algorithm. The new architecture should exploit the FPGA to implement a large number of digit serial processors to operate on serial streams of data arising form the ultra high density serial network architecture. The management of this new high performance architecture should be both distributed and transparent to the user. A new programming model should support the runtime customization of the internal logic of one or more processors to more closely match to the desired model of computation.

Therefore, there is a need for a method and system that addresses the above and other problems. The above and other problems are addressed by the exemplary embodiments of the present invention, which provide the means to dynamically create specialized High Performance Computers on request from a variety of components, including, but not limited to, reconfigurable logic processors, disk storage, and high speed memory banks. Hardware components have network interfaces, and specialized computers are constructed by interconnecting a set of components over the same network. In one aspect, the invention includes a new architecture for routinely building specialized computers rapidly upon request, a new architecture for utilizing large arrays of disk storage devices, a new architecture for deploying large arrays of random access memory devices, a new network protocol and switch component, and a new architecture that fully integrates a network as the sole component interconnect element. In another aspect, the invention includes a new management model for the allocation and reallocation of computer components, computer storage devices, and computer networks. In another aspect, the invention includes a new massively parallel processing model based on the employment of unprecedented numbers of digit serial processors for use with these FPGA components, computer storage devices and computer networks that employ less power and less space than current high performance computers. In another aspect, the invention includes enhancements to FPGA components to facilitate the use of digit serial processors. In another aspect, the invention, includes a new method for programming reconfigurable processing devices. In another aspect, the invention includes a new architecture for reconfigurable processing devices.

Accordingly, in exemplary aspects of the present invention there is provided a method, system, computer program product, and devices corresponding to a computer architecture, a computer management system, a programming model, and a programming language product for high performance computing, according to the exemplary embodiments.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary of a new computer architecture including random access memory, hard disk drive array, and processor elements, wherein elements are deployed by connecting them to a new network element;

FIG. 2 illustrates an exemplary hard disk drive array element with its configuration, management and network interface module;

FIG. 3 illustrates an exemplary random access memory array element with its configuration, management and network interface module;

FIG. 4 illustrates an exemplary FPGA array element with its configuration, management and network interface module;

FIG. 5 illustrates an example of how a network is extended by the network components that are part of each component's management and interface modules;

FIG. 6 illustrates an exemplary means of implementing an integrated FPGA and random access memory array more suitable for use with FPGA technology;

FIG. 7 illustrates the bitwise transpose operation on 64 bit operands to enable emulation of 64 synchronous data streams from random access memory;

FIG. 8 illustrates an exemplary means of implementing an optional FPGA design that directly connects serial transceiver data to serial configured block rams with control logic to connect to hardware implementations of digit serial processors; and

FIG. 9 illustrates an exemplary system, according to the exemplary embodiments of the present invention of FIGS. 1-8.

### DETAILED DESCRIPTION OF THE PREFERRED EMBODIMENTS

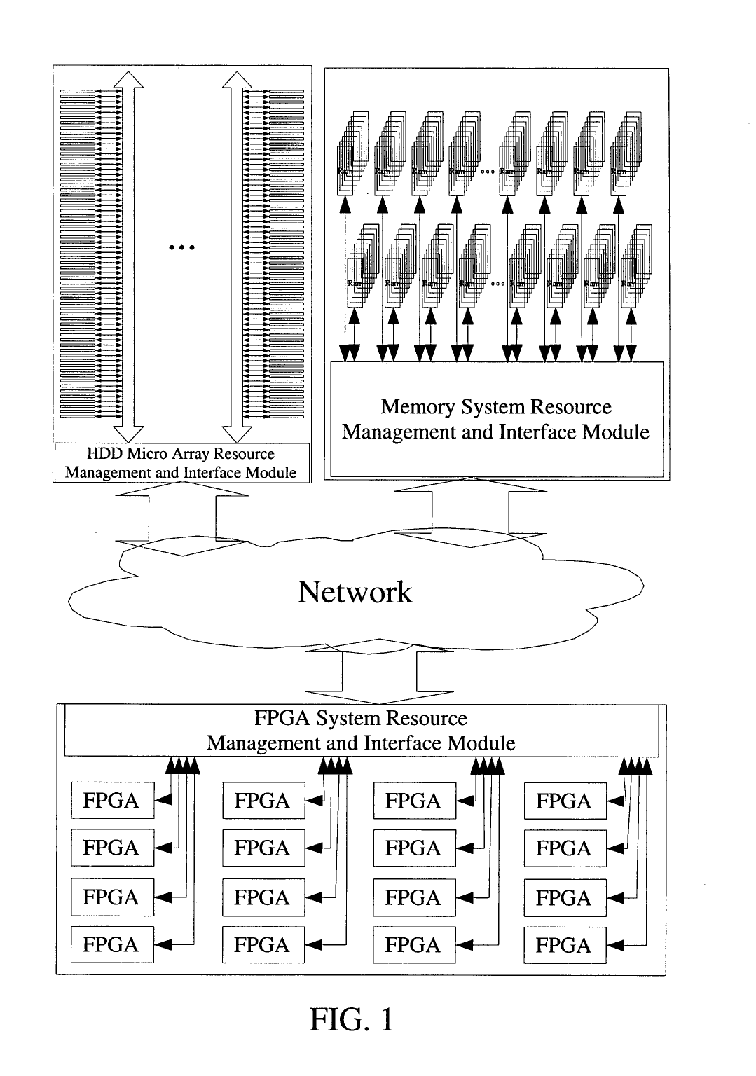

Referring now to the drawings, wherein like reference numerals designate identical or corresponding parts throughout the several views, and more particularly to FIG. 1 thereof, there is illustrated a new architecture that is designed in such a way that computer hardware components are collected onto circuit board elements and connected to a high capacity bit serial network element. Common computer hardware components, including, but not limited to, random access memories, hard disk drives and FPGA processors, and a common network are shown.

When connected to the network, each element advertises the presence and availability of its hardware components. Client processes with network access then issue structured requests for hardware components that result in their allocation and configuration to create specialized computers. These specialized computers are created “on the fly” at runtime, as opposed to the time of manufacture. Client requests are received and processed by software agents that then collaborate with the element's resource management module to select, assign network identities, and enable and connect the hardware component to the network to form the application-specialized computer system.

Each element's management and interface module maintains component allocation status, responds to status requests, executes resource management commands, performs de-allocation operations upon termination, and interacts with the element's interface module. Client programs notify the request processing agent when the computation completes. The request agent then notifies the elements' resource management modules and each element's corresponding components are de-allocated and made available for subsequent re-use. Element are discussed in detail below.

In FIG. 1, the network element is constructed from the new computer architecture's high capacity bit serial integrated circuits. The integrated circuits implement a specialized computation oriented serial packet switched network. Cut through routing is used throughout. Packet size is variable up to 4 K bits. Clock rate is configurable so that a 2:1 speed ratio can be specified where ⅓ of the ports can be set double the clock rate of the remaining ⅔.

Each element can include a number of switch components so that the interface module can provide a separate serial port to each component. ⅔ of each switch component's ports are reserved for component ports and ⅓ are reserved for connection to the network element.

The new computer architecture supports fine grain massively parallel processing by enabling numerous algorithmic methods to exploit inherent operational parallelism. A high degree of operational parallelism is achieved with both a large number of execution units and a large number of independent data streams capable of matching the execution speed of the execution units. This new computer architecture supports the creation of a large number of digit serial processors with tightly coupled inter-processor connections and a large number of independent external serial data streams. The number of available hardware components is proportional to the port capacity of the network.

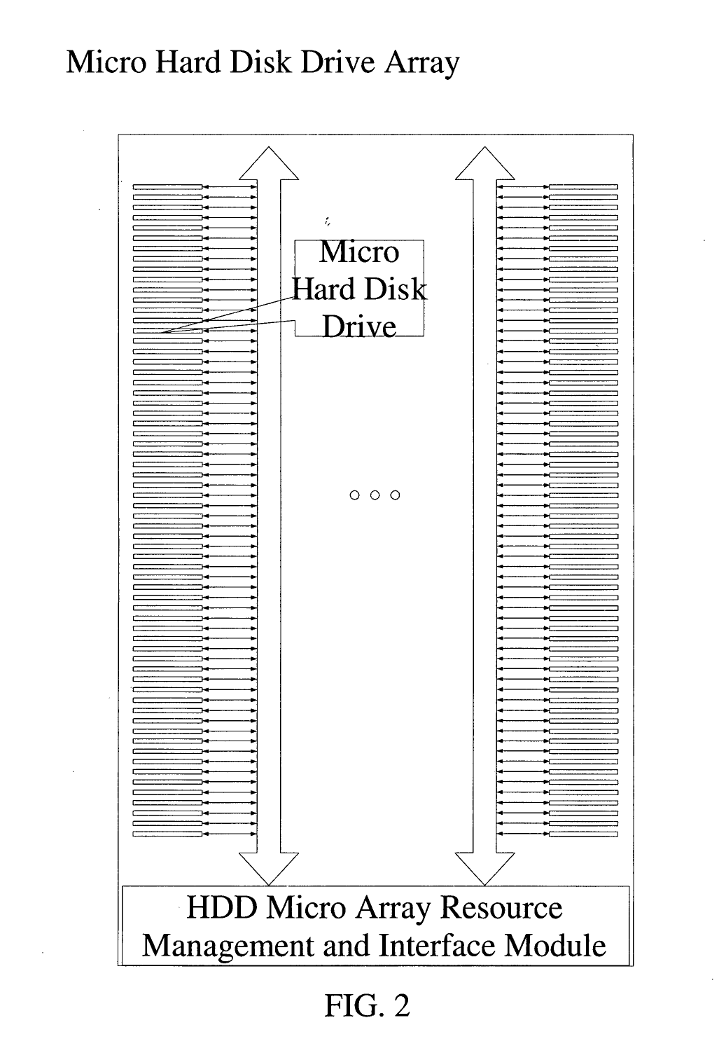

FIG. 2 illustrates a single printed circuit board that connects to an array of hard disk drives, typically of the micro disk size, 1.8 in. or less. Each hard disk drive (HDD) is modified to support a serial interface compatible with the new computer architectures high capacity switch design. Each HDD's serial interface is connected to the board's network interface module. The management module allocates one or more HDDs by issuing commands to the network interface module to enable its connection to an external port. The management module maintains resource allocation status information, responds to status requests, executes supervisory commands, and performs de-allocation procedures.

HDDs are assigned attributes including, but not limited to: un-initialized; initialized with a specific file system; including named persistent data; and initialized as part of a named high reliability Redundant Array of Independent Disks (RAID) group.

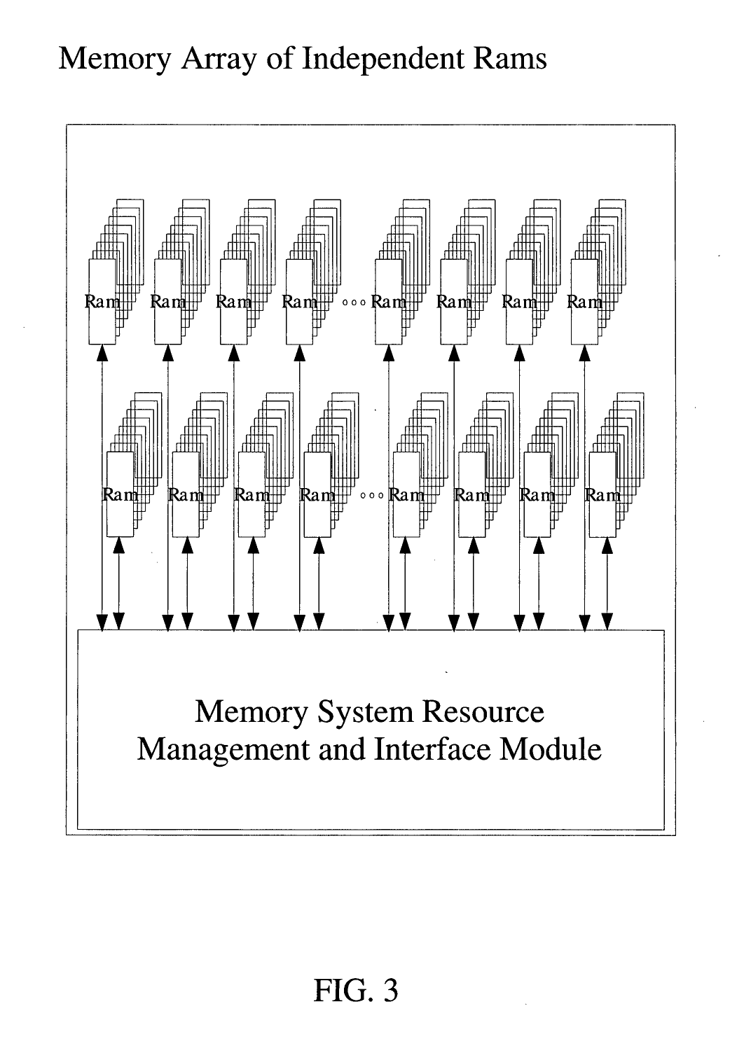

FIG. 3 illustrates a single printed circuit board element that can include an array of independent random access memory devices. Each memory device is associated with its own network port through the network interface module. The management module maintains resource allocation status information, responds to status requests, executes supervisory commands, and performs de-allocation procedures.

In FIG. 3, the management module performs bidirectional read write buffering to speed contiguous data stream access. The management module can be configured to perform application specific caching strategies relative to the allocated set of memory components.

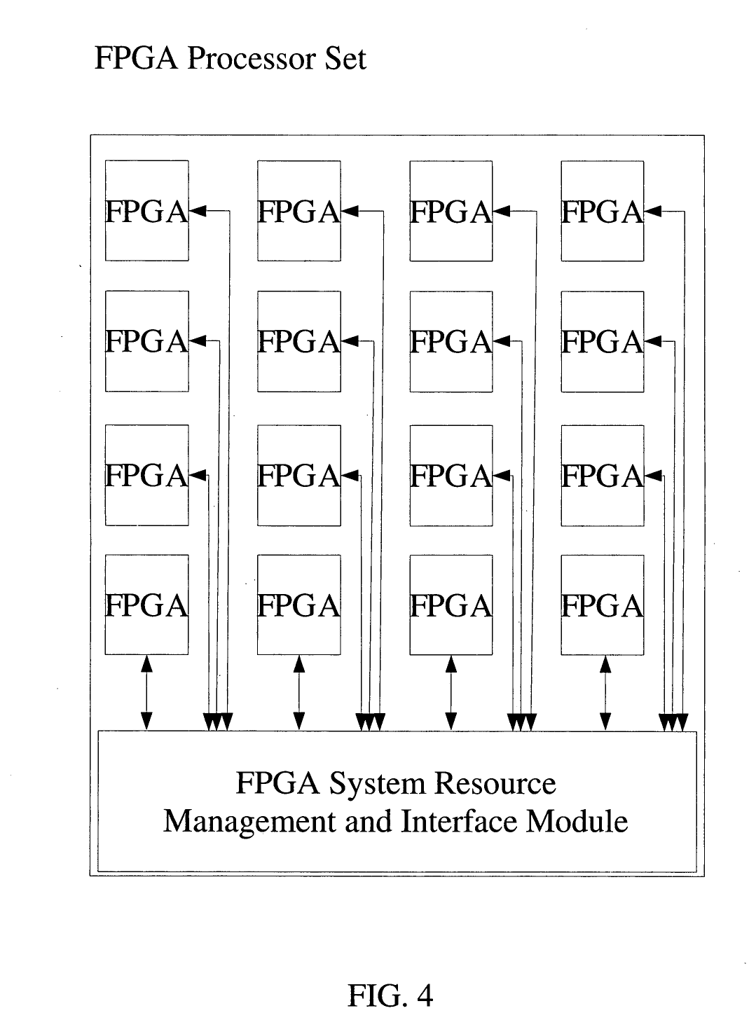

FIG. 4 illustrates a single printed circuit board element that can include an array of independent FPGA devices. Each FPGA has each of its serial communication ports connected to a network switch port. The interface module controls the operation of the network switch chip and assigns the contents of the forwarding tables. Each FPGA has its power, configuration interface (e.g., Joint Test Action Group, JTAG), and auxiliary signal lines connected to the board's management module.

The management module supplies power independently to each FPGA, configures FPGAs to perform computation, and monitors the auxiliary signal lines. The management module advertises the availability of its components to network connected entities. The management module processes allocation request sent by request agents and receives and implements configuration packages from the request agent.

Configuration packages include configuration files for the allocated FPGAs, communication data for initializing forwarding tables in the switch components, and an optional script that specifies how each FPGA is to respond to the state of the signal lines.

The management and interface module provides individual FPGA chip level debugging support. Individual FPGA debugging information is collected by the management module and sent to the requesting client. A debugging monitor loaded onto the management module manages the interaction with the client to carry out client commands and to return results.

The management module maintains resource allocation status information, responds to status requests, executes supervisory commands, and performs de-allocation procedures.

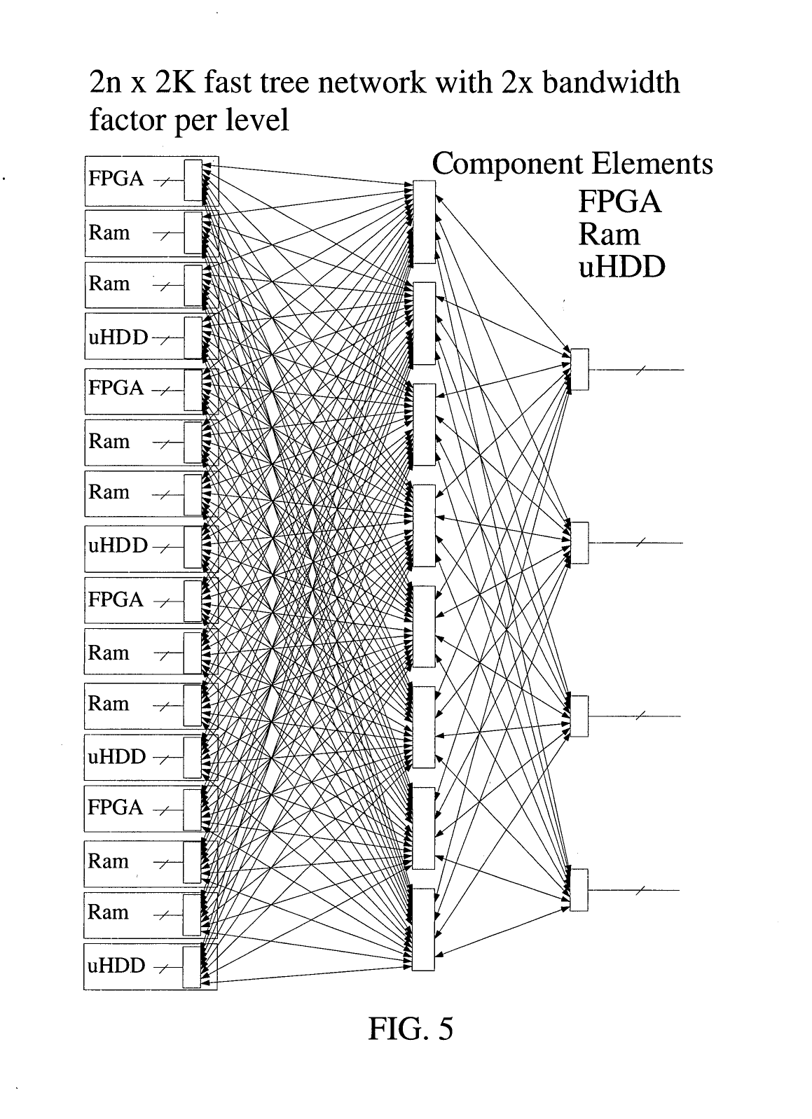

FIG. 5 illustrates an example of how the elements of FIGS. 2-4 connect into a typical network. The network element is built with the new high capacity switch chips. Each element in FIGS. 2-4 can include switch chips that connect element components into the network element and form the leaf level switch layer. Leaf level switches are under control of their respective management and interface modules. The remainder of the network is designed and under control of the network manager.

Switch chips have port selectable data rates. Component port data rate is selected to comply with the maximum clock rate of the FPGA logic. The remaining ports on element switches are set at double the data rate to connect into the network element. Data rate doubling is selected for each level in the tree until the maximum communication data rate is reached.

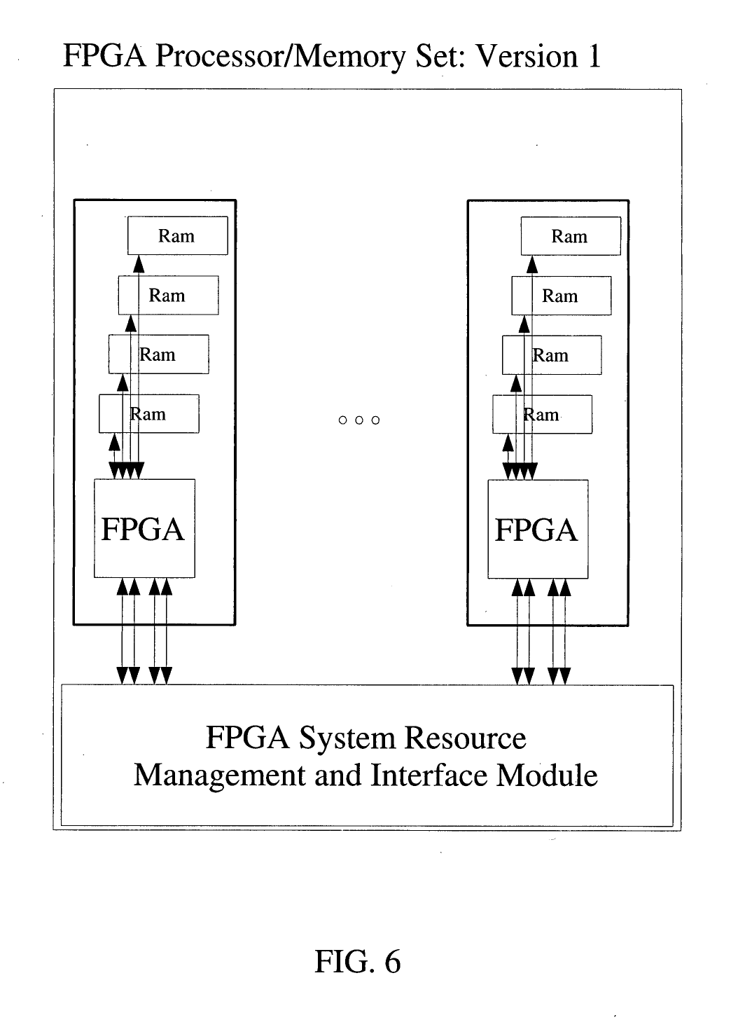

FIG. 6 illustrates a computer system that embodies many aspects of the design of the new computer architecture, but it can be made with currently available commercial-off-the-shelf (COTS) computer hardware components.

The computer system illustrated in FIG. 6 includes two printed circuit board assemblies: an FPGA based processor board and a management and network interface module.

The processor board can include an FPGA and multiple memory banks. The FPGA's communication links, JTAG interface, and auxiliary signaling lines are routed to its interface connector. The processor board is fitted with board presence, power control, pass through indicator actuator lines, and memory bank select signals.

The management and network interface module can include control circuitry to sense the presence of each FPGA processor board, to individually supply and enable power each FPGA processor board, to enable and power selected memory banks, to configure and debug the activity of each FPGA on each processor board, to execute a script specifying the handling of state changes of the signal lines, to sense the presence of each processor board, to control external indicators on each board, to implement a supervisory network interface, and to initialize and manage network switch chips.

Several of these FPGA boards connect to a single management and interface module. Multiple FPGA boards and a management and interface module board are combined into a single chassis. The network interface module supplies several network ports to connectors mounted to a panel on the chassis. Multiple chassis can be interconnected through an external switch of the same type used in the network interface module to form large systems of these FPGA-based processor boards.

The system illustrated in FIG. 6 can emulate digit serial processing aspects of the new architecture described in FIGS. 1-5. By reorganizing data sets, one or more memory banks can emulate multiple bit serial data streams. By performing a bit-wise transposition of conventionally stored data sets, each datum is stored as a bit sequence aligned to a single memory data bus bit location. Each fetch from a memory bank including a transposed data set returns one bit each from multiple operand streams. The number of operand streams is equal to the bit size of the memory bank data bus. Each data stream is, then, connected to an algorithmic arrangement of digit serial processors on the FPGA.

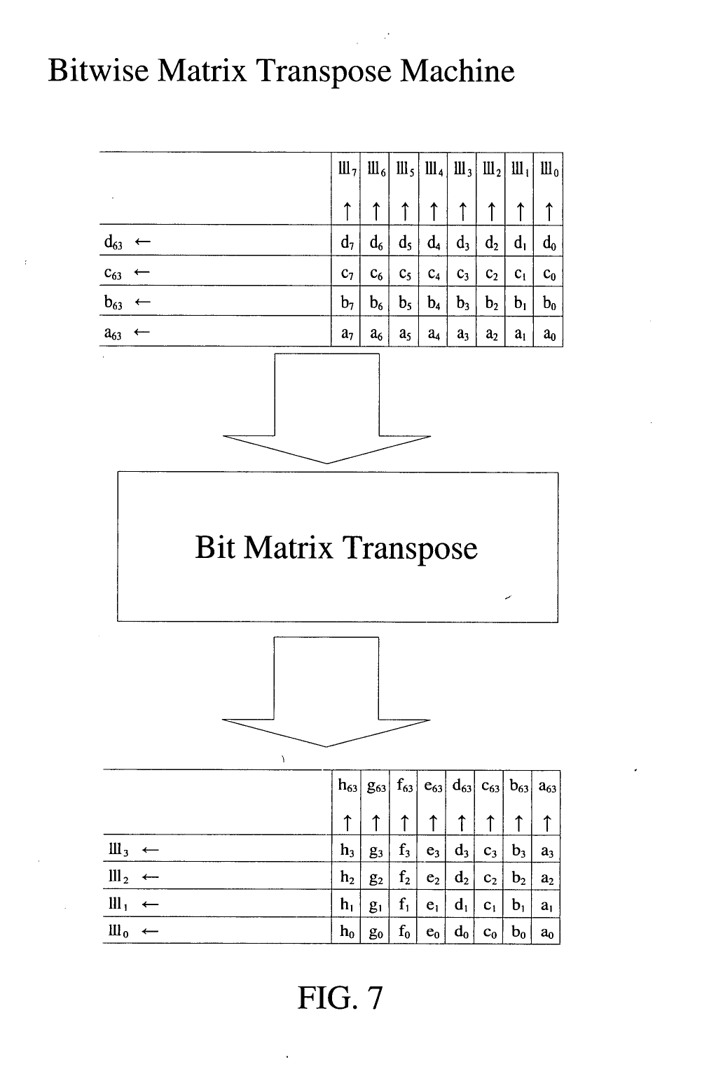

FIG. 7 illustrates a method for performing the bit-wise transpose within an FPGA. The method uses a number of dual port rams where one port is set equal in size to the word width and the other port is set to a width of 1 bit. Words are written to each ram in succession on the word port. Once each of the rams includes a word, a transposed word is made from concatenating one bit read from each of the rams' single bit port. The transposed word is then written to the memory bank, or supplied directly to a digit serial processing machine. Transposed data sets are returned to the original storage format with a reverse transpose process. Bit-wise transposition and digit serial processing provides several benefits including better utilization of FPGA interconnect and logic resources, increased parallel computation, lower latency, variable precision data and the most efficient pipeline processing.

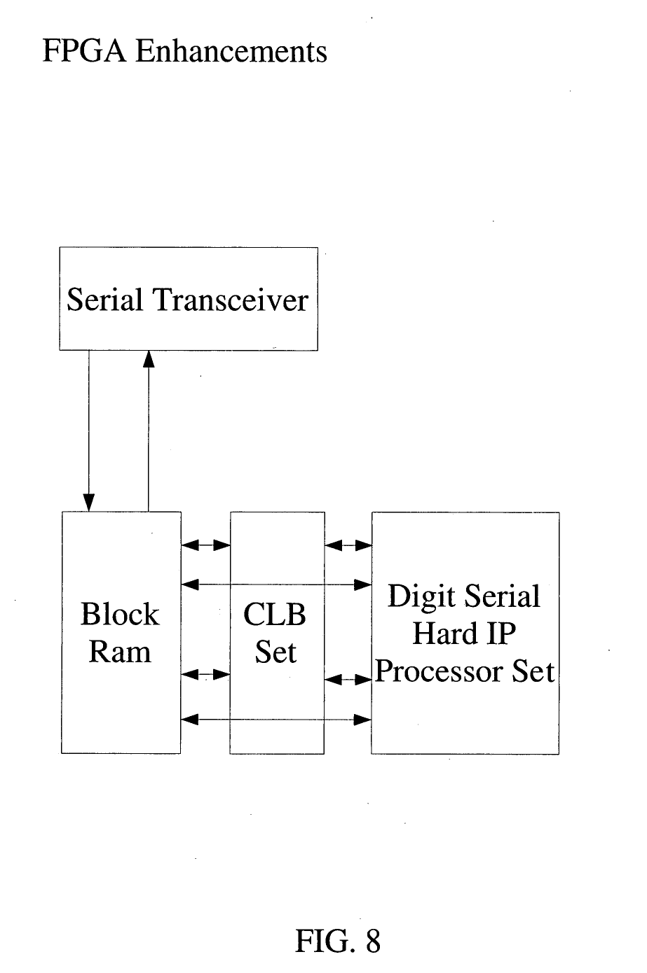

FIG. 8 illustrates enhancements for next generation FPGA architectures that facilitate the use of large numbers of digit serial processors. Enhancements include: direct implementation of digit serial processor hardware sets on the integrated circuit and the ability to connect serial transceiver directly to block rams.

A set of digit serial processors includes, but is not limited to, adders/subtracters, multipliers, dividers and comparators. Digit serial processors can be configured to operate in either most significant bit first or least significant bit first modes. Block rams include configuration options to supply operands in either order. Each digit serial processor set is augmented with control and alignment components such as multiplexers, demultiplexers, replicators, selectors, and flip-flops. Complex logic blocks (CLBs) provide additional processing, control, and alternate processing paths. Components from a digit serial processor set are selected and interconnected to implement a subset of a processing stream. Multiple subsets are connected to form more complex computing structures.

Another aspect of the FPGA enhancements is the capability to connect the serial data bit stream from the transceiver interface directly to block rams. The block ram enhancements include input and output signals to indicate the data stream status including, but not limited to, “operand available,” “end of stream,” “flush stream,” and “reverse operand sequence.”

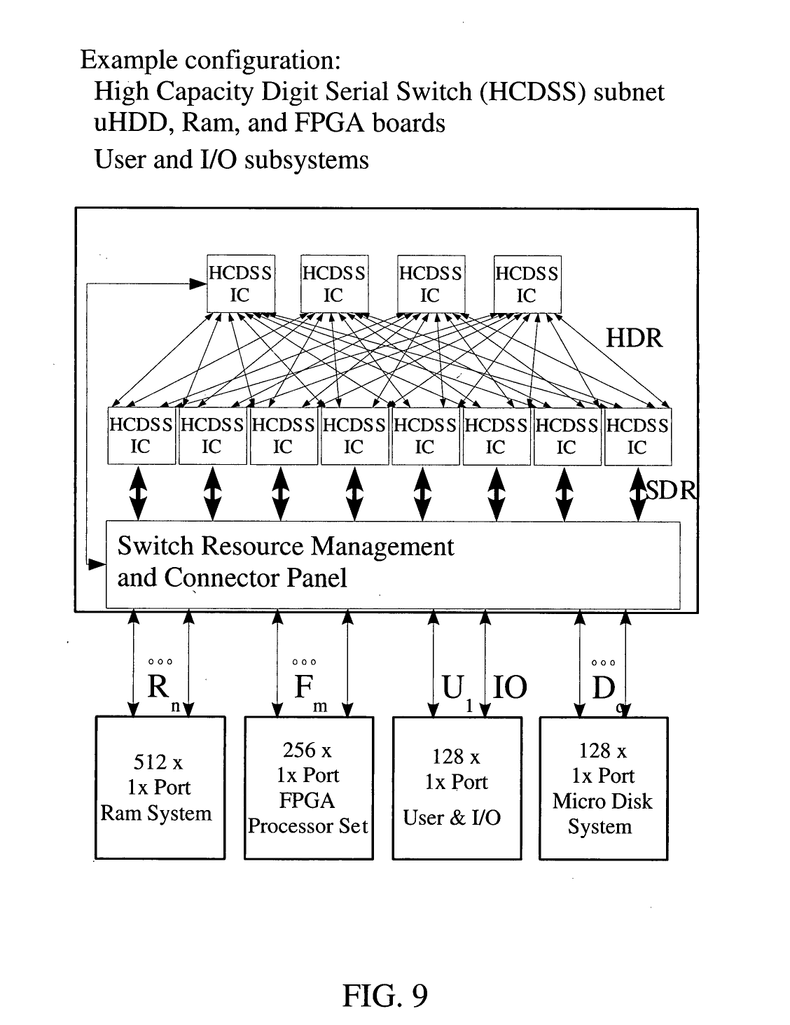

FIG. 9 illustrates an example of a small scale deployment utilizing each element of the new computer architecture. User and I/O elements are shown connected to the same subnet. Such user and I/O elements are fitted with interface devices compatible with the subnet. Multiple users request and acquire component resources from the new computer architecture and designate multiple sources and sinks for data. Computer architecture components are shared amongst a plurality of users as each user releases his allocation when their task completes.

The above-described devices and subsystems of the exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the new architecture of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A system for designing, specifying and/or creating customized computer architectures from a selection of network connected computer components, the system comprising at least one of:
(a) a high capacity bit serial network switch integrated circuit;
(b) a network built from a plurality integrated circuits recited in (a);
(c) a hard disk drive (HDD) array element including a plurality of HDDs, each HDD connecting to a serial network port of an integrated circuit recited in (a);
(d) a random access memory element including a plurality of memory chips, each connected to a serial network port of an integrated circuit recited in (a);
(e) a multi-field programmable gate array (FPGA) element including a plurality of FPGAs, each with multiple serial links of which each is connected to a serial network ports of an integrated circuit recited in (a);
(f) a distributed resource management software system designed to at least one of:
(i) advertise the availability of computer components,
(ii) allocate computer components to requesting agents,
(iii) configure computer components as specified,
(iv) maintain component allocation status, and
(v) process supervisory commands;
(g) FPGA design enhancements to facilitate the implementation of massively parallel digit serial processing architectures;
(h) a programming language optimized for expressing array-based and data flow specifications;
(i) a programming language compiler that compiles to a set of components that comprise a digit serial set of execution units and associated control devices;
(j) a commercial off-the-shelf (COTS)-based version of a computer architecture capable of emulating many of such embodiment's attributes; and
(k) a system method for emulating multiple digit serial data streams by performing a bit transpose operation on each datum.

2. A method corresponding to one or more of the components of the system of claim 1.

3. A computer program product corresponding to one or more of the components of the system of claim 1.

4. A device corresponding to one or more of the components of the system of claim 1.
